(19) United States
(12) Patent Application Publication
(10) Pub. No.: US 2015/0135773 A1
(43) Pub. Date: May 21, 2015

(54) PROCESS AND DEVICE FOR MANUFACTURING A HOLLOW GLASS BODY

(71) Applicant: Saint-Gobain Oberland AG, Bad Waldsee (DE)

(72) Inventor: Stefan Jaenecke, Bad Waldsee (DE)

(21) Appl. No.: 14/410,874

(22) PCT Filed: Jun. 25, 2013
(86) PCT No.: PCT/EP2013/063304

§ 371 Date: Dec. 23, 2014

(30) Foreign Application Priority Data
Jun. 28, 2012 (DE) 12173979.1

(51) Int. Cl. C03B 9/16; C03B 9/32; C03B 9/193

(52) U.S. Cl. CPC C03B 9/165; C03B 9/193; C03B 9/1932; C03B 9/32
USPC 65/76; 65/79; 65/77; 65/72; 65/323; 65/229; 65/243

(57) ABSTRACT

A process for manufacturing a hollow glass body by means of an individual section (IS) machine in a press and blow, narrow-neck press and blow, or blow and blow process, with a driving means that moves a plunger axially, to produce selected geometrical contours in a glass gob. The process steps include:
aligning and attaching a positioning ring directly, or via intermediate elements, on the IS machine, on which positioning ring a positioning device is provided,
aligning a guide tube, on an outer jacket surface on which a guide device is disposed and interacts with the positioning device of the positioning ring in the assembled condition,
aligning a plunger with a non-rotationally symmetrical plunger head with a guide device disposed thereon , which interacts with a positioning device provided in the assembled condition on, or in, the inner jacket surface of the guide tube such that the non-rotationally symmetrical outer contour of the plunger head passes through an aperture tool allocated to the IS machine during the press or blow procedure, and the contours of the plunger head and of the aperture tool generate the profile of the inner, or outer, wall of the hollow glass body.

### BACKGROUND OF THE INVENTION

1. Field of the Invention

The present invention relates to a process and device for manufacturing a hollow glass body by means of an individual section (IS) machine, by means of which the hollow glass body is produced in a press and blow, or a blow and blow, process.

2. Description of the Prior Art

Such processes and devices are used, in particular, in mass production for manufacturing hollow glass bodies, such as water or beer bottles, and the like. The hollow glass bodies have differently sized external contours, and are usually manufactured on machines referred to as IS (individual section) machines. The IS machines are characterised by a first preform process step in which a preform is produced from a gas gob by means of a press stroke, or compressed air, and is then directly transferred to an adjacent, additional processing station on the IS machine at which a blowing process is used for generating the definitive contour of the hollow glass body, as a result of which hollow glass bodies with an indentation can be manufactured. In this case, a large number of such IS machines are arranged adjacent to one another, meaning that a large number of such hollow glass bodies can be manufactured as part of mass production within tightly limited time windows.

In what is referred to as the press and blow process for manufacturing hollow glass bodies, there is usually provision for raising a plunger, and its round plunger head, to a certain position by means of a driving means, and to put on a pre-former, together with the aperture tool. The aperture tool is provided with a round internal contour. The diameter of the plunger head is smaller than the internal diameter of the aperture tool, as a result of which the plunger head can pass through the aperture tool without damaging it. The gap between the internal contour of the aperture tool and the external contour of the plunger head corresponds to the wall thickness of the hollow glass body, according to the manufacturing process. As soon as the pre-former and the aperture tool are put on by means of a gripper arm attached to the IS machine in a swivelling arrangement, a glass gob is filled through a passage opening provided in the pre-former, and comes into contact with the plunger head. After the heated glass has been filled, the passage opening is closed by means of a preform base, and the plunger is advanced by driving means in the direction of the aperture tool, or the preform base. As a result of this, the plunger makes an indentation of a specified contour in the molten glass gob, which is provided subsequently as a pouring aperture, for example in the case of a bottle. As soon as this pressing procedure has finished, the plunger is moved by the driving means from an upper dead centre position to a lower dead centre position, and the gripper arm takes the aperture tool, and the glass pressed into it as a preform, to an adjacent processing station, at which the definitive contour of the hollow glass body is subsequently generated by blowing with compressed air.

In what is referred to as the blow and blow process, the plunger is provided with at least one compressed air line. The plunger is advanced in the direction of the aperture tool, and through it, such that a trough is created in the glass gob and into which compressed air is subsequently blown, as a result of which the compressed air creates a preform of the glass gob, and the contours are created on the hollow glass body.

These processing procedures and the use of IS machines have proven effective in practice for mass production of hollow glass bodies. However, it is not known for a non-round, or non-rotationally symmetrical contour, to be incorporated into the preform of the hollow glass body by means of a correspondingly configured plunger head. Also, it is not known for the outer contour of the preform of the hollow glass body to be aligned at any geometrical configuration about the inner contour.

### SUMMARY OF THE INVENTION

The objective of the present invention is to provide a process, and a device of the aforementioned kind, by means of which to incorporate almost any geometrical contours into a glass gob by means of an IS machine, in order subsequently to produce the hollow glass body with its final geometrical configuration in a further processing step on the IS machine, without damage occurring during the press stroke of the plunger, or its plunger head, and the aperture tool.

In accordance with the present invention, the plunger is inserted in the guide tube in a specified position and orientation, and a guide device in the outer contour of the guide tube interacts with a positioning device disposed on the inner wall of the positioning ring, as a result of which the plunger, the guide tube, and the positioning ring, are aligned on the IS machine, which serves as a reference point. Consequently, it is possible for a plunger head to be worked on to the plunger that is provided with almost any outer contour, for example, an oval, ellipse, or a contour with a concave/convex or undulating profile, so as to produce a hollow glass body with an inner contour that is non-round or non-rotationally symmetrical in the area of the aperture.

The aperture tube is aligned in a positional orientation by means of the pre-former and the gripper arm, and is held during the processing operation, and the gripper arm is articulated on the IS machine, as a result of which there is a position alignment in relation to the IS machine for the aperture tool, meaning that the plunger head and the aperture tool are aligned with one another such that the plunger head does not damage the aperture tool and, instead, passes through it with the effect that the contours of the aperture tool and the plunger head generate the profile of the wall of a hollow glass container in the area of its aperture.

### BRIEF DESCRIPTION OF THE DRAWINGS

The drawings show an embodiment configured in accordance with the present invention, which is subsequently explained in detail. In the drawings:

FIG. 1 is an exploded view showing a device comprising a guide tube in which a plunger with axial movement is inserted, and of an aperture tool between which a heated mass of glass is filled in order to form a hollow glass body with a rectangular pouring aperture;

FIG. 2a is a sectional view showing the device in accordance with FIG. 1, in a lower dead centre point;

FIG. 2b shows the device of FIG. 2a, with a filled glass gob and pre-former mounted in position, in a raised status;

FIG. 2c is a sectional view of the device and the pre-former in accordance with FIG. 2c, in an upper dead centre point;

FIG. 3a is a perspective view of the hollow glass body manufactured according to the process steps shown in FIG. 2a to 2c or 2d, with a rectangular pouring aperture;

FIG. 3b to

FIG. 3d are plan views showing various geometrical profiles of the wall of the hollow glass container in the area of the aperture; and

FIG. 4 is a perspective view showing the plunger according to FIG. 1.

### DESCRIPTION OF THE PREFERRED EMBODIMENTS

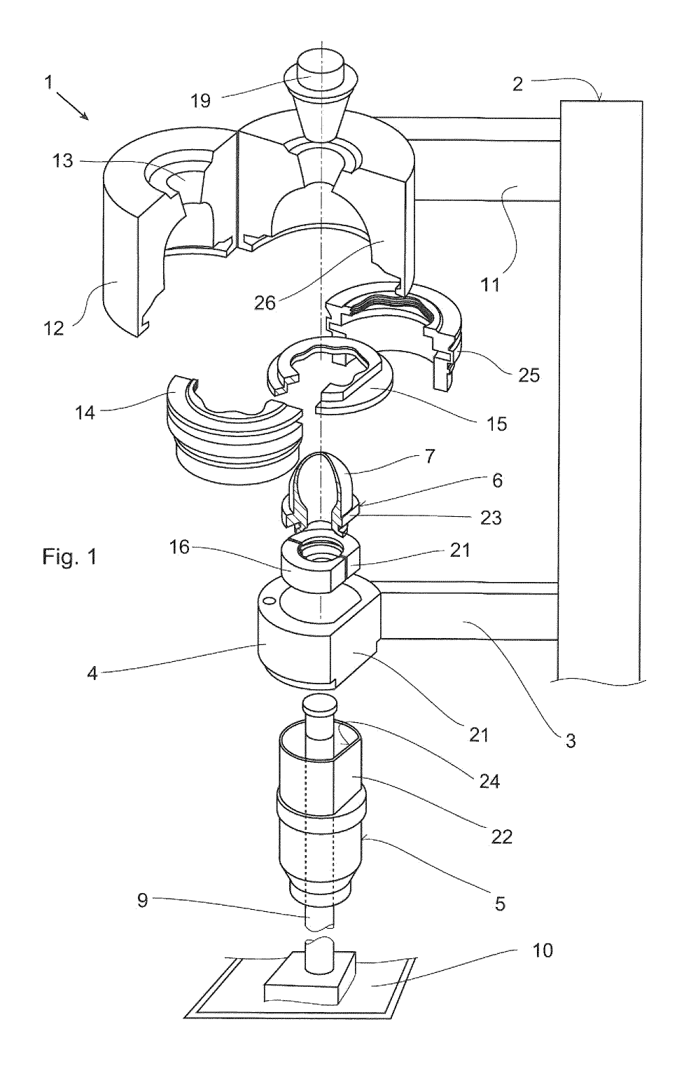

FIG. 1 shows a device 1 for pressing a heated glass gob 27, from which a preform 28 is created in a first process step and, by a second process step, a hollow glass body 30 on a machine referred to as an IS machine 2. The IS machine 2 serves as the reference point for aligning the components that form the device 1. The IS machine 2 forms the glass gob 27 into the hollow glass body 30 with indentations in the press and blow, narrow-neck press and blow, or blow and blow, process.

The IS machine 2 comprises a holding arm 3 to which a positioning ring 4 is attached. The positioning ring 4 is provided with a positioning device 21 formed onto its inner jacket surface in the form of a contact surface. The positioning ring 4 encloses a guide tube 5 and holds it in an orientated position. For alignment of the guide tube 5, there is a guide device 22 disposed on it in the form of a contact surface, with the effect that in assembled condition the positioning device 21 and the guide device 22 lie flush, one above the other, such that the positioning ring 4 specifies the position of the orientated alignment, and fixing of the guide tube 5.

A positioning device 24, in the form of a contact surface, is disposed on the inner jacket surface of the guide tube 5, by means of which a plunger 6 axially movable in the guide tube 5, is held because the plunger 6 is provided with a guide device 23 thereon in the form of a contact surface, which, in assembled condition, is arranged flush above the positioning device 24 of the guide tube 5, with the effect that interaction between the guide device 23 and the positioning device 24 holds the plunger 6 aligned with the IS machine 2, and in a positional orientation in the guide tube 5.

It would also be possible to use differently configured components in order to form the positioning devices 21 and 24, as well as the guide devices 22 and 23. For example, it is possible for linear guide grooves to be worked into the positioning ring 4, the guide tube 5, and the plunger 6, and to insert a block or a rail into the corresponding linear guide grooves between these components, with the effect that these are subjected to a force in the circumferential direction and are supported, and also that these produce a positionally orientated positioning of the plunger 6 in relation to the guide tube 5, and of the guide tube 5 in relation to the positioning ring 4.

To enable the plunger 6 to be moved axially in the guide tube 5, the plunger 6 is connected to a piston rod 9 that is in driving active contact with a driving means 10, for example, a pneumatically, or hydraulically, operated piston. The drive means 10 thus enables the piston rod 9, and the plunger 6, to be actuated in a stroke arrangement between a lower and upper dead centre position.

To allow the plunger 6 to be exchanged in the least possible time, a plunger adapter 16 is provided comprising two half shells adapted to be removed from the plunger 6 when it has moved out of the guide tube 5. The plunger adapter 16 provides a driving connection between the plunger 6 and the piston rod 9.

FIG. 1 further shows the plunger 6 provided with a plunger head 7 formed or fixed onto it with a rectangular outer contour.

In order to form the glass gob 27, an aperture tool 14, that interacts with the plunger head 7, is provided and comprising two half shells enclosed by a pre-former 12 with a two-piece configuration in the assembled condition. The two halves of the aperture tool 14 are enclosed by a cover ring 15, and are aligned with one another by a pre-former provided with a guide device 26. The pre-former 12 is aligned with the IS machine 2 as the reference point by means of a gripper arm 11 articulated on the IS machine 2 in a swivelling arrangement. Furthermore, the inner jacket surface of the pre-former 12 is provided with the guide device 26 that interacts with a positioning device 25 disposed on the outer wall of the aperture tool 14 such that the aperture tool 14 is held in a positional orientation in the pre-former 12, and thus the position and/or alignment of the aperture tool 14 is adapted to be set exactly by means of the cover ring 15, the pre-former 12, and the gripper arm 11, in relation to the IS machine 2, with the effect that the plunger 6, or its plunger head 7, is aligned with the aperture tool 14, and the plunger head 7 can be inserted into the aperture tool 14 without the outer contour of the plunger head 7 contacting the inner wall of the aperture tool 14. This is because an air gap must be provided between the aperture tool 14 and the plunger head 7 corresponding to the wall thickness of the hollow glass body 30.

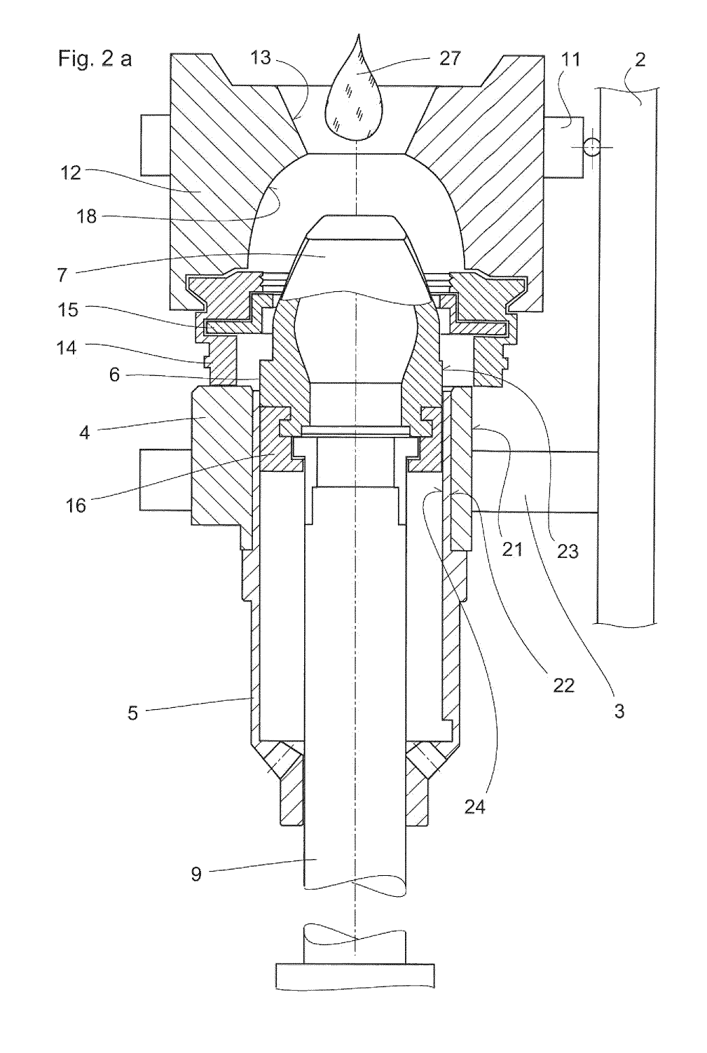

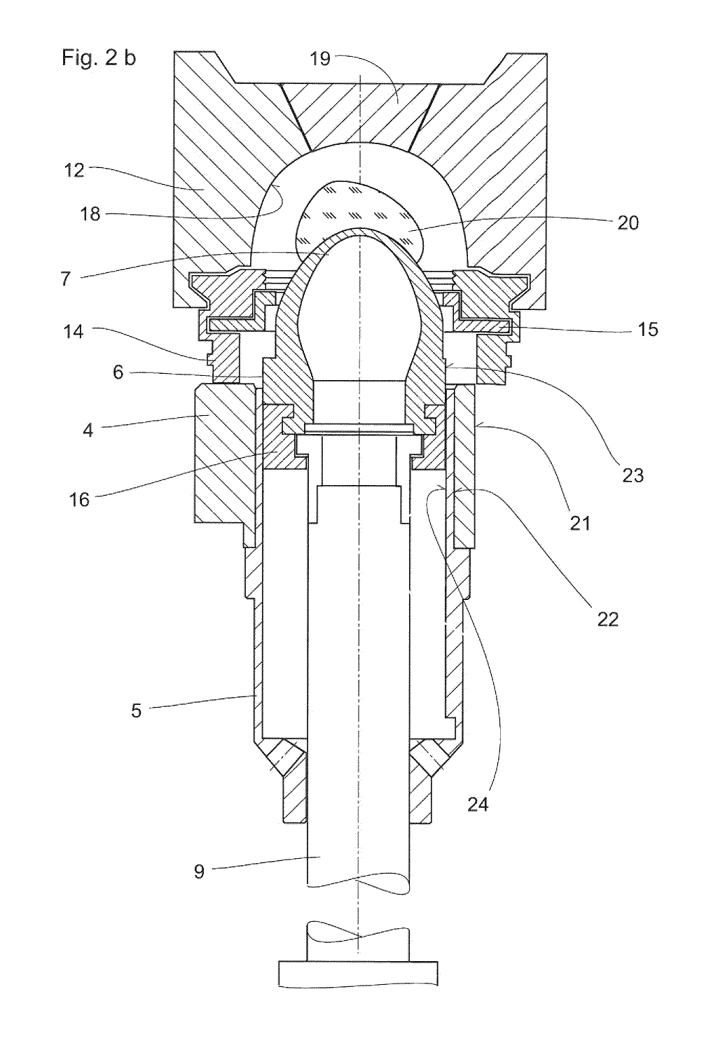

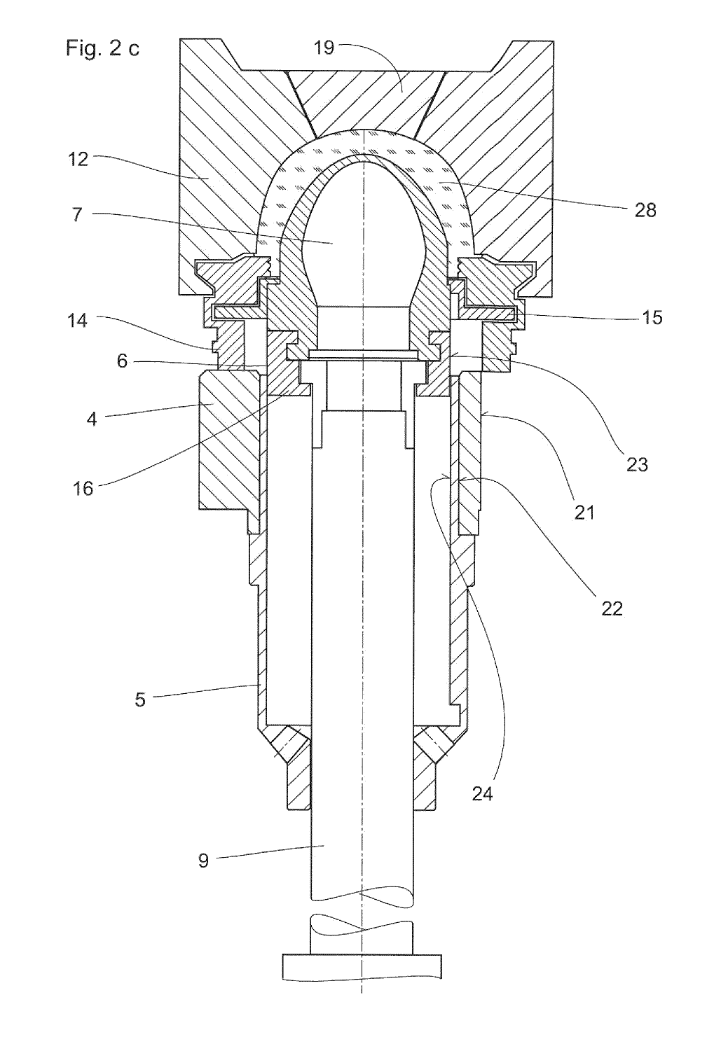

FIG. 2a shows the plunger 6 lifted from the lower top centre position to a middle position and the pre-former 12, as well as the aperture tool 14, placed on the plunger 6, enclosing it. The pre-former 12 is provided with a passage opening 13 disposed therein, through which the glass gob 27 is filled onto the plunger head 7.

FIG. 2b shows that the passage opening 13 is closed by a pre-form base 18, in order to provide a completely closed contact surface for the glass gob 27 to be in contact with during the advance of the plunger head 7.

FIG. 2c shows the plunger 6 moved, or advanced, to a top dead centre position, and that this stroke movement manufactures the preform 28 from the glass gob 27. The outer contour of the plunger head 7 is pressed into the preform 28 in this case, with the effect that the rectangular outer contour of the plunger head 7 is worked into the preform 28, and specifically into its inner wall.

The inner contour of the aperture tool 14, as well as the inner contour of the pre-former 12, influences the outer contour of the preform 28. In particular, the aperture tool 14 is provided with a circumferential ring worked into the outer wall of the preform 28 as an undercut, which is adapted to serve as the holding ring for a crown cap on the manufactured hollow glass body 30.

The pre-former 12 is removed after the press stroke of the plunger 6. The plunger 6 initially moves to the lower dead centre position, and the gripper arm 11 transfers the aperture tool 14, and the preform 28 held by the aperture tool 14, to an adjacent processing station of the IS machine 2, where the hollow glass body 30 is subsequently manufactured in the blow process with indentations.

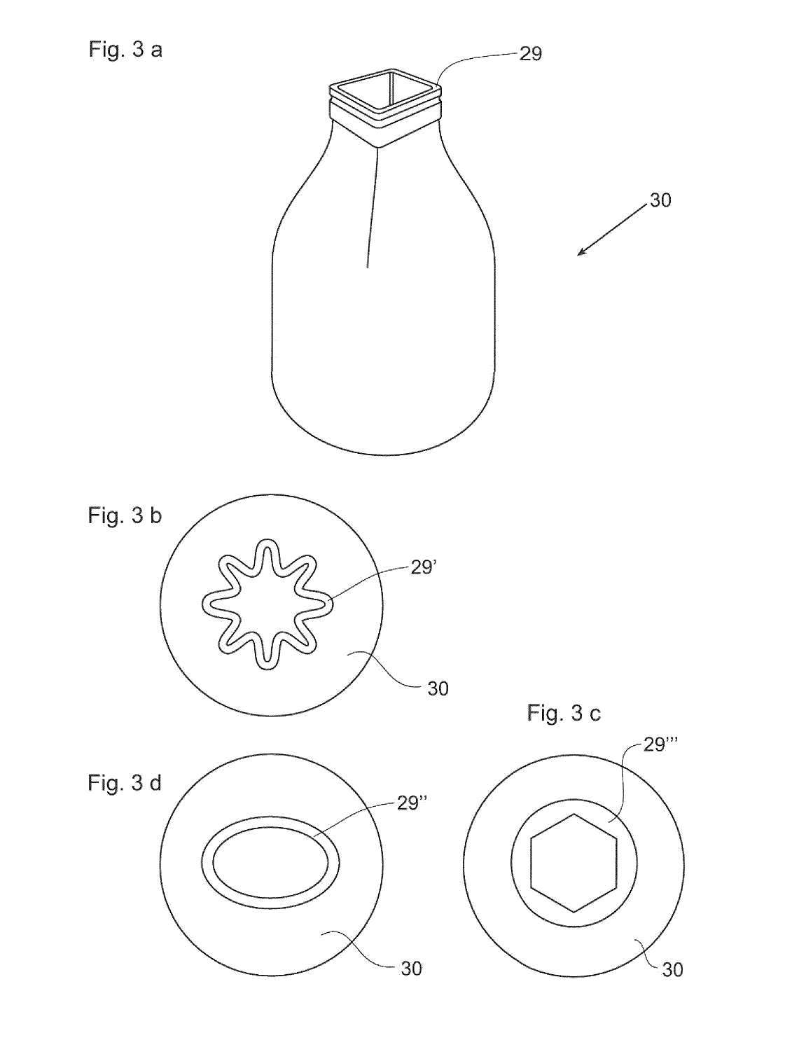

FIG. 3a shows the hollow glass body 30 in the form of a bottle. The hollow glass body 30 is provided with a rectangular pouring aperture 29, because, as shown in FIGS. 1 to 2d, the outer contour of the plunger head 7 exhibits a rectangular configuration, and this creates the inner wall of the pouring aperture 29. The aperture tool 14 has been aligned corresponding to the outer contour of the plunger head 7, as a result of which a rectangular shaped outer contour can be created for the pouring aperture 29 of the hollow glass body 30.

FIG. 3b shows that the inner contour of the hollow glass body 30 is configured as a flower, or undulating shape, and that the outer contour of the hollow glass body 30 is arranged around the correspondingly shaped pouring aperture 29. Accordingly, the plunger head 7 is configured with an undulating, or flower-shaped, outer contour, and the inner contour of the aperture tool 14 is configured with a round shape.

FIG. 3c shows a hexagonal inner contour with a round outer contour of the hollow glass body 30 enclosing the inner contour, as a result of which it is possible to produce an inner contour with any desired shape on a hollow glass body 30 which can then be sealed by a round crown cap.

FIG. 3d shows an oval, or elliptical, configuration of the inner and outer contours of the pouring aperture 29 of a hollow glass body 30.

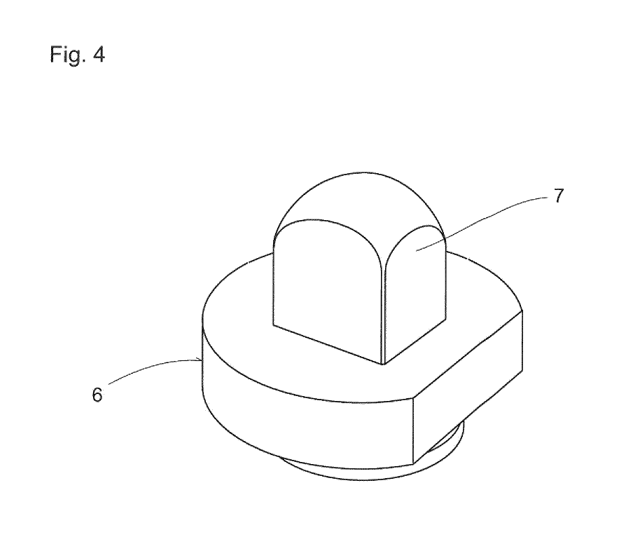

FIG. 4 shows a magnified view of the plunger 6 and the plunger head 7. The plunger head 7 is provided with a rectangular, and preferably square, outer contour, which is non-rotationally symmetrical. The plunger head 7 can adopt any non-rotationally symmetrical outer contour in this case; it can, for example, be polygonal, oval, elliptical, or configured with a concave or convex curvature or an undulating shape. The known inner contours with a round configuration are, on the other hand, regarded as rotationally symmetrical. It is necessary for at least one plane of symmetry to exist in order to serve as the parting plane for the aperture tool 14 and the pre-former 12.

1. Process for manufacturing a hollow glass body by means of an individual section (IS) machine in a press and blow, narrow-neck press and blow, or blow and blow, process, with a driving means that moves a plunger axially,
the process comprising the steps of:
aligning and attaching a positioning ring directly, or via intermediate elements, on the IS machine, on which positioning ring a positioning device is provided,
aligning a guide tube, on an outer jacket surface on which a guide device is disposed, which interacts with the positioning device of the positioning ring in the assembled condition,
aligning a plunger with a non-rotationally symmetrical plunger head with a guide device therein, which interacts with a positioning device provided in the assembled condition on, or in, the inner jacket surface of the guide tube, such that the non-rotationally symmetrical outer contour of the plunger head passes through an aperture tool allocated to the IS machine during the press or blow procedure, and the contours of the plunger head, and of the aperture tool, generate a profile of the inner or outer wall of the hollow glass body.

2. The process in accordance with claim 1,
wherein
the aperture tool is enclosed by a pre-former with a two-piece structure while a glass gob is filled in through a passage opening worked into the pre-former onto the plunger head of the plunger, and the pre-former holds the aperture tool with positional orientation in a circumferential direction, and in a lengthways direction, by means of a positioning device disposed on the inner wall of the pre-former, and a guide device disposed on the outer jacket surface of the aperture tool, and a cover ring is aligned with the aperture tool.

3. The process in accordance with claim 2,
wherein
before a press stroke of the plunger, or before compressed air is blown in through the plunger, the passage opening of the pre-former is closed by a preform base.

4. The process in accordance with claim 3,
wherein
after the press stroke of the plunger, or after compressed air is blown into the glass gob, the pre-former, and the preform base, are removed from the plunger, and the aperture tool and a preform are passed on a gripper arm to another processing station of the IS machine for completing the hollow glass body by means of indentations.

5. A device for manufacturing a hollow glass body, the device comprising an IS machine on which a holding arm and a swivelling gripper arm are disposed, a positioning ring mounted on the holding arm, a guide tube is enclosed by the positioning ring, a plunger in contact with the inner jacket surface of the guide tube is held with axial guidance, and of a piston rod is in a driven connection with the plunger and a driving means,
wherein
a non-rotationally symmetrical plunger head is mounted on said plunger, said plunger comprising a guide device that interacts with a positioning device on or in an inner jacket surface of the guide tube such that the position of said plunger is aligned in a circumferential direction with the position of the guide tube, and is positionally orientated, such that said plunger is held and guided in the circumferential direction during an axial stroke, a guide device is disposed on or in the outer jacket surface of said guide tube, and a positioning device is provided in the inner jacket surface of the positioning ring and interacts with the guide device of said guide tube such that said guide tube is aligned with the positioning ring and is held with positional orientation in the circumferential direction.

6. The device in accordance with claim 5,
wherein
the gripper arm of said IS machine is provided with a two-piece pre-former with a passage opening therein, and the pre-former comprises an aperture tool and a cover ring on the outer jacket surface, and a positioning device is provided that interacts with a guide device disposed in the inner sidewall of the pre-former such that said aperture tool and said cover ring are held in an orientated position and supported in the circumferential direction.

7. The process in accordance with claim 5,
wherein
the positioning device on the positioning ring, and the guide device of said guide tube comprises surfaces flush with one another, and are in contact substantially without play, and are configured as linear guides, with a block or a rail inserted therein for positioning and guidance.

8. The device in accordance with claim 5,
wherein
said guide device of said plunger, and the positioning device of said guide tube comprise contact surfaces that lie flush, one above the other.

9. The device in accordance with claim 6,
wherein
said positioning device of said aperture tool and the guide device of said pre-former are configured as contact surfaces that lie flush one above the other.

10. The device in accordance with claim 6,
wherein
after a press stroke of said plunger, or after a glass gob has been blown out by compressed air, a preform of a hollow glass container, together with said aperture tool, are transferred by the gripper arm of said IS machine to an adjacent processing station.

11. The device in accordance with claim 5,
wherein
the plunger head of the plunger is selectively polygonal, oval, elliptical or of a concave, or convex, curvature, or of an undulating configuration.

12. The device in accordance with claim 6,
wherein
at least one ring is formed on an inner jacket surface of said aperture tool, by means of which a circumferential groove is disposed in the outer contour of the hollow glass container.

13. The device in accordance with claim 6,
wherein
an inner contour of said aperture tool is adapted to the outer contour of said plunger head, or that the inner contour of said aperture tool is provided with a different configuration from the outer contour of said plunger head.

14. The device in accordance with claim 13,
wherein
a final shape of the hollow glass container is achieved by a forming body and the forming body exhibits a geometry corresponding to the geometry of the hollow glass container created before the aperture tool and the plunger head, or a differently configured geometry.

15. (canceled)
